(19) United States
(12) Patent Application Publication
(10) Pub. No.: US 2025/0039747 A1
(43) Pub. Date: Jan. 30, 2025

(54) MULTI-PATH PROCESSING METHOD AND APPARATUS, DEVICE AND SYSTEM

(71) Applicant: FUJITSU LIMITED, Kawasaki-shi (JP)

(72) Inventors: Guorong LI, Beijing (CN); Meiyi JIA, Beijing (CN); Su YI, Beijing (CN); Xin WANG, Beijing (CN)

(73) Assignee: FUJITSU LIMITED, Kawasaki-shi, Kanagawa (JP)

(21) Appl. No.: 18/915,487

(22) Filed: Oct. 15, 2024

Related U.S. Application Data
(63) Continuation of application No. PCT/CN2022/087650, filed on Apr. 19, 2022.

(51) Int. Cl. H04W 36/00; H04L 1/1607; H04W 92/18

(52) U.S. Cl. CPC H04W 36/0061; H04L 1/1614; H04W 92/18

(57) ABSTRACT

Embodiments of this disclosure provide a multi-path processing method and apparatus, a device and a system. The multi-path processing method includes: receiving indication information, the indication information including information on activation and/or deactivation and/or handover of a direct path, and/or, including information on activation and/or deactivation and/or handover of an indirect path; and performing activation and/or deactivation and/or handover of the direct path, and/or perform activation and/or deactivation and/or handover of the indirect path, according to the indication information.

### CROSS-REFERENCE TO RELATED APPLICATION

This application is a continuation application of International Application PCT/CN2022/087650 filed on Apr. 19, 2022, and designated the U.S., the entire contents of which are incorporated herein by reference.

### TECHNICAL FIELD

This disclosure relates to the field of communication technologies.

### BACKGROUND

In Release 17, sidelink relay (SL relay) was studied, which includes a scenario of UE-to-Network relay. In this scenario, a remote UE communicates with a network device via a relay UE, wherein NR Uu is used on a Uu link of the relay user equipment, and an NR sidelink is used on a PC5 interface between the remote UE and the relay UE. In the scenario of UE-to-Network relay, the relay UE is also referred to as a UE-to-Network relay UE.

It should be noted that the above description of the background is merely provided for clear and complete explanation of this disclosure and for easy understanding by those skilled in the art. And it should not be understood that the above technical solution is known to those skilled in the art as it is described in the background of this disclosure.

### SUMMARY

It was found by the inventors that in Release 17, a remote terminal equipment may communicate with a network device in the relay manner described above, or the remote terminal equipment may directly communicate with the network device. In other words, in Release 17, a remote terminal equipment simultaneously supports only a single path to communicate with a network device.

In Release 18, solutions that support multi-path or multiple paths will be studied. A multi-path scenario may be: a remote terminal equipment may be connected to the same network device (e.g. a gNB) by simultaneously using a direct path and an indirect path. For example, the direct path may be that the remote terminal equipment is connected directly to the network device via a Uu interface, and the indirect path may be that the remote terminal equipment is connected to the network device via a layer 2 (L2) UE-to-Network relay.

Currently, in multi-path solutions, there is no solution for how to simultaneously activate at least two paths (direct path and indirect path) and how to perform dynamic handover between the at least two paths.

In order to solve at least one of the above problems, embodiments of this disclosure provide a multi-path processing method and apparatus, a device and a system.

According to one aspect of the embodiments of this disclosure, there is provided a multi-path processing apparatus, including:
a receiving unit configured to receive indication information, the indication information including information on activation and/or deactivation and/or handover of a direct path, and/or, including information on activation and/or deactivation and/or handover of an indirect path; and
a processing unit configured to perform activation and/or deactivation and/or handover of the direct path, and/or perform activation and/or deactivation and/or handover of the indirect path, according to the indication information.

According to another aspect of the embodiments of this disclosure, there is provided a multi-path processing method, including:
receiving indication information, the indication information including information on activation and/or deactivation and/or handover of a direct path, and/or, including information on activation and/or deactivation and/or handover of an indirect path; and
performing activation and/or deactivation and/or handover of the direct path, and/or performing activation and/or deactivation and/or handover of the indirect path, according to the indication information.

According to a further aspect of the embodiments of this disclosure, there is provided a remote UE, including a memory and a processor, the memory storing a computer program, and the processor being configured to execute the computer program to carry out the multi-path processing method as described in the other aspect of the embodiments of this disclosure.

According to still another aspect of the embodiments of this disclosure, there is provided a multi-path processing apparatus, including:
a transmitting unit configured to transmit indication information to a remote user equipment or a relay user equipment, wherein the indication information includes information on activation and/or deactivation and/or handover of a direct path, and/or, includes information on activation and/or deactivation and/or handover of an indirect path.

According to yet another aspect of the embodiments of this disclosure, there is provided a multi-path processing method, including:
transmitting indication information to a remote user equipment or a relay user equipment, wherein the indication information includes information on activation and/or deactivation and/or handover of a direct path, and/or, includes information on activation and/or deactivation and/or handover of an indirect path.

According to yet still another aspect of the embodiments of this disclosure, there is provided a network device, including a memory and a processor, the memory storing a computer program, and the processor being configured to execute the computer program to carry out the multi-path processing method as described in the yet another aspect of the embodiments of this disclosure.

According to yet further another aspect of the embodiments of this disclosure, there is provided a multi-path processing apparatus, including:
a receiving unit configured to receive second indication information transmitted by a network device, the second indication information including information on activation and/or deactivation and/or handover of an indirect path.

According to yet further still another aspect of the embodiments of this disclosure, there is provided a multi-path processing method, including:
receiving second indication information transmitted by a network device, the second indication information including information on activation and/or deactivation and/or handover of an indirect path.

According to further still another aspect of the embodiments of this disclosure, there is provided a relay user equipment, including a memory and a processor, the memory storing a computer program, and the processor being configured to execute the computer program to carry out the multi-path processing method as described in the yet further still another aspect of the embodiments of this disclosure.

According to even further another aspect of the embodiments of this disclosure, there is provided a communication system, including the network device and/or the remote UE and/or the relay user equipment as described in the further aspect of the embodiments of this disclosure.

An advantage of the embodiments of this disclosure exists in that the remote user equipment receives the indication information, and performs activation and/or deactivation and/or handover on the direct path and/or performs activation and/or deactivation and/or handover on the indirect path. Hence, in a multi-path scheme, activation and/or deactivation and/or handover may be performed on the paths of the remote user equipment, which is conducive to dynamically adjusting the use of the paths in multiple paths, and improvement of reliability and rate of data transmission of the remote UE.

With reference to the following description and drawings, the particular embodiments of this disclosure are disclosed in detail, and the principle of this disclosure and the manners of use are indicated. It should be understood that the scope of the embodiments of this disclosure is not limited thereto. The embodiments of this disclosure contain many alternations, modifications and equivalents within the scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

Elements and features depicted in one drawing or embodiment of the disclosure may be combined with elements and features depicted in one or more additional drawings or embodiments. Moreover, in the drawings, like reference numerals designate corresponding parts throughout the several views and may be used to designate like or similar parts in more than one embodiments.

FIG. 1 is a schematic diagram of a scenario 1 of remote UE-to-Network relay;

FIG. 2 is a schematic diagram of a scenario 2 of remote UE-to-Network relay;

FIG. 3 is a schematic diagram of a scenario 3 of remote UE-to-Network relay;

FIG. 4 is a schematic diagram of a communication system of an embodiment of this disclosure;

FIG. 5 is a schematic diagram of a multi-path scenario of an embodiment of this disclosure;

FIG. 6 is a schematic diagram of a multi-path protocol stack structure of an embodiment of this disclosure;

FIG. 7 is a schematic diagram of the multi-path processing method of an embodiment of a first aspect of this disclosure;

FIG. 8 is a schematic diagram of a bitmap of the embodiment of the first aspect of this disclosure;

FIG. 9 is a schematic diagram of the multi-path processing apparatus of an embodiment of a second aspect of this disclosure;

FIG. 10 is a schematic diagram of the multi-path processing method of an embodiment of a third aspect of this disclosure;

FIG. 11 is a schematic diagram of the multi-path processing apparatus of an embodiment of a fourth aspect of this disclosure;

FIG. 12 is a schematic diagram of the multi-path processing method of an embodiment of a fifth aspect of this disclosure;

FIG. 13 is a schematic diagram of the multi-path processing apparatus of an embodiment of a sixth aspect of this disclosure;

FIG. 14 is a schematic diagram of the terminal equipment of an embodiment of a seventh aspect of this disclosure; and

FIG. 15 is a schematic diagram of the network device of the embodiment of the seventh aspect of this disclosure.

### DETAILED DESCRIPTION

These and further aspects and features of this disclosure will be apparent with reference to the following description and attached drawings. In the description and drawings, particular embodiments of the disclosure have been disclosed in detail as being indicative of some of the ways in which the principles of the disclosure may be employed, but it is understood that the disclosure is not limited correspondingly in scope. Rather, the disclosure includes all changes, modifications and equivalents coming within the terms of the appended claims.

In the embodiments of this disclosure, terms “first”, and “second”, etc., are used to differentiate different elements with respect to names, and do not indicate spatial arrangement or temporal orders of these elements, and these elements should not be limited by these terms. Terms “and/or” include any one and all combinations of one or more relevantly listed terms. Terms “contain”, “include” and “have” refer to existence of stated features, elements, components, or assemblies, but do not exclude existence or addition of one or more other features, elements, components, or assemblies.

In the embodiments of this disclosure, single forms “a”, and “the”, etc., include plural forms, and should be understood as “a kind of” or “a type of” in a broad sense, but should not defined as a meaning of “one”; and the term “the” should be understood as including both a single form and a plural form, except specified otherwise. Furthermore, the term “according to” should be understood as “at least partially according to”, the term “based on” should be understood as “at least partially based on”, except specified otherwise.

In the embodiments of this disclosure, the term “communication network” or “wireless communication network” may refer to a network satisfying any one of the following communication standards: long term evolution (LTE), long term evolution-advanced (LTE-A), wideband code division multiple access (WCDMA), and high-speed packet access (HSPA), etc.

And communication between devices in a communication system may be performed according to communication protocols at any stage, which may, for example, include but not limited to the following communication protocols: 1G (generation), 2G, 2.5G, 2.75G, 3G, 4G, 4.5G, and 5G and new radio (NR) in the future, etc., and/or other communication protocols that are currently known or will be developed in the future.

In the embodiments of this disclosure, the term “network device”, for example, refers to a device in a communication system that accesses a user equipment to the communication network and provides services for the user equipment. The network device may include but not limited to the following devices: a base station (BS), an access point (AP), a transmission reception point (TRP), a broadcast transmitter, a mobile management entity (MME), a gateway, a server, a radio network controller (RNC), a base station controller (BSC), etc.

The base station may include but not limited to a node B (NodeB or NB), an evolved node B (eNodeB or eNB), and a 5G base station (gNB), etc. Furthermore, it may include a remote radio head (RRH), a remote radio unit (RRU), a relay, or a low-power node (such as a femto, and a pico, etc.). The term “base station” may include some or all of its functions, and each base station may provide communication coverage for a specific geographical area. And a term “cell” may refer to a base station and/or its coverage area, depending on a context of the term.

In the embodiments of this disclosure, the term “user equipment (UE)” or “terminal equipment (TE) or terminal device” refers to, for example, an equipment accessing to a communication network and receiving network services via a network device. The user equipment may be fixed or mobile, and may also be referred to as a mobile station (MS), a terminal, a subscriber station (SS), an access terminal (AT), or a station, etc.

The terminal equipment may include but not limited to the following devices: a cellular phone, a personal digital assistant (PDA), a wireless modem, a wireless communication device, a hand-held device, a machine-type communication device, a lap-top, a cordless telephone, a smart cell phone, a smart watch, and a digital camera, etc.

For another example, in a scenario of the Internet of Things (IoT), etc., the terminal equipment may also be a machine or a device performing monitoring or measurement. For example, it may include but not limited to a machine-type communication (MTC) terminal, a vehicle mounted communication terminal, a device to device (D2D) terminal, and a machine to machine (M2M) terminal, etc.

Moreover, the term “network side” or “network device side” refers to a side of a network, which may be a base station or one or more network devices including those described above. The term “user side” or “terminal side” or “terminal equipment side” refers to a side of a user or a terminal, which may be a UE, and may include one or more terminal equipments described above. “A device” in this text may refer to a network device, and may also refer to a terminal equipment, except otherwise specified.

Scenarios of UE-to-Network relay shall be described below by way of examples; however, this disclosure is not limited thereto.

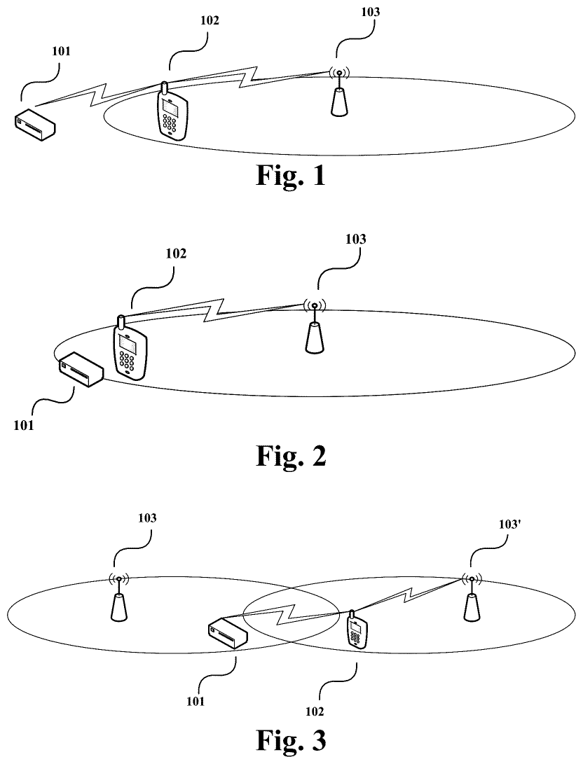

FIG. 1 is a schematic diagram of a scenario 1 of remote UE-to-Network relay, FIG. 2 is a schematic diagram of a scenario 2 of remote UE-to-Network relay, and FIG. 3 is a schematic diagram of a scenario 3 of remote UE-to-Network relay.

As shown in FIG. 1, in scenario 1, a first terminal equipment 101 (remote UE) is out of coverage (OOC) of a network device 103, and a second terminal equipment 102 (relay UE) is in coverage (IC) of the network device 103.

As shown in FIG. 2, in scenario 2, the first terminal equipment 101 (remote user equipment) is in coverage (IC) of the network device 103, and the second terminal equipment 102 (relay user equipment) is in coverage of the network device 103.

As shown in FIG. 3, in scenario 3, the first terminal equipment 101 (remote user equipment) is in coverage of the network device 103, and the second terminal equipment 102 (relay user equipment) is in coverage of another network device 103′.

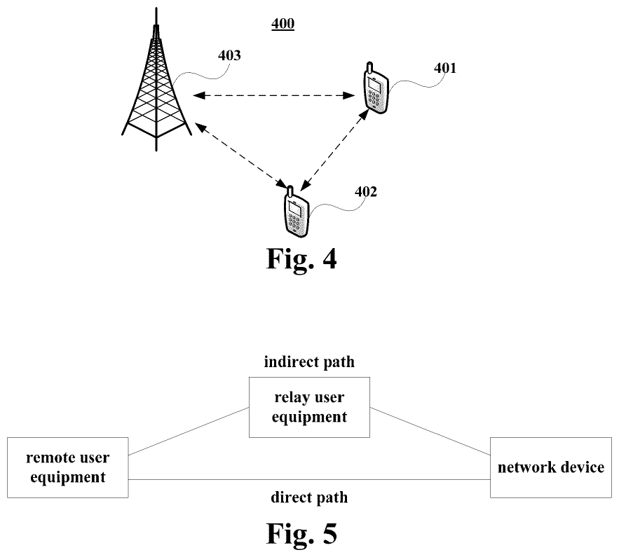

FIG. 4 is a schematic diagram of a communication system of an embodiment of this disclosure, illustrating a case taking a remote user equipment, a relay user equipment and a network device as an example. As shown in FIG. 4, a communication system 400 may include a remote user equipment 401, a relay user equipment 402 and a network device 403. The remote user equipment 401 is connected to the network device 403 via a direct path and an indirect path. For the sake of simplicity, description is given in FIG. 4 by taking two terminal equipments (one remote user equipment and one relay user equipment) and one network device as an example; however, the embodiment of this disclosure is not limited thereto.

In the embodiment of this disclosure, existing services or services that may be implemented in the future may be performed between the network device 403 and the remote user equipment 401 and the relay user equipment 402. For example, such services may include but not limited to an enhanced mobile broadband (eMBB), massive machine type communication (MTC), ultra-reliable and low-latency communication (URLLC), etc.

FIG. 5 is a schematic diagram of a multi-path scenario of an embodiment of this disclosure. As shown in FIG. 5, in the embodiment of this disclosure, the remote user equipment may communicate with the network device via a direct path and an indirect path simultaneously. For example, the remote user equipment may communicate with the network device via a Uu interface (direct path), and communicate with the same network device via the relay user equipment (indirect path).

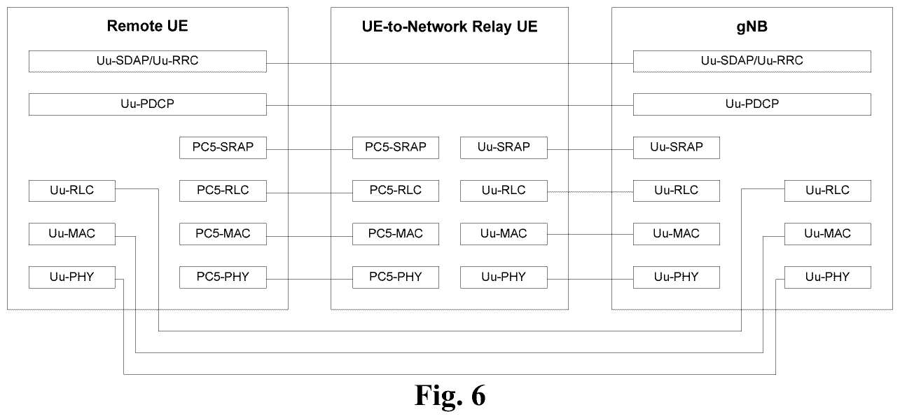

FIG. 6 is a schematic diagram of a multi-path protocol stack structure of an embodiment of this disclosure. As shown in FIG. 6, the direct path between the remote user equipment and the network device uses a Uu interface protocol stack, and the indirect path between the remote user equipment and the network device is transmitted via L2 UE-to-Network relay, using the PC5 interface and a Uu interface protocol stack.

In some embodiments, as shown in FIG. 6, an RRC layer, an SDAP layer and a PDCP layer in the remote user equipment are equivalent to an RRC layer, an SDAP layer and a PDCP layer in the network device, and data of the PDCP layer of the remote user equipment may be transmitted to the network device via the indirect path passing the relay user equipment. For example, a PDCP PDU of the remote user equipment may be transmitted to the relay UE via a PC5-SRAP, a PC5-RLC, a PC5-MAC and a PC5-PHY, and then the relay UE transmits the data to a gNB via its own Uu interface protocol stack (a Uu SRAP, a Uu RLC, a Uu MAC, and a Uu PHY). The gNB side receives the data from a Uu interface protocol stack peer to the relay UE, and transmits the data to the Uu-PDCP of the gNB for processing. Or, data of the PDCP layer of the remote user equipments may be transmitted to the network device via a direct path. For example, the PDCP PDU of the remote user equipment may be transmitted to the gNB via a Uu RLC, a Uu MAC, and a Uu PHY. The gNB side receives the data from a Uu interface protocol stack peer to the remote UE, and transmits the data to the Uu-PDCP of the gNB for processing. In addition, in the direct path and/or the indirect path, there may be one or more RLC entities (Uu RLC entities or PC5 RLC entities) associated with a PDCP entity of a radio bearer.

In some embodiments, as shown in FIG. 6, in the protocol stack of the gNB side, a Uu MAC entity may also be used to process data of the remote user equipment and the relay user equipment.

In some embodiments, as shown in FIG. 6, in the remote user equipment, an MAC entity may also be used to perform PC5-MAC and Uu MAC operations.

Various implementations of the embodiments of this disclosure shall be described below with reference to the accompanying drawings. These implementations are illustrative only, and are not intended to limit this disclosure.

### Embodiment of a First Aspect

The embodiment of this disclosure provides a multi-path processing method, applicable to a remote user equipment, such as the remote user equipment 401 in FIG. 4.

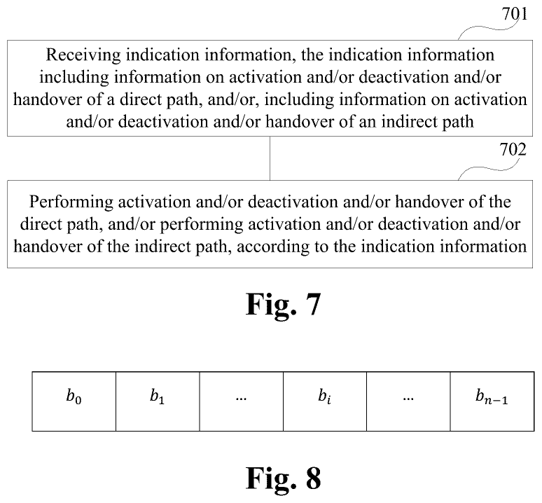

FIG. 7 is a schematic diagram of the multi-path processing method of the embodiment of the first aspect of this disclosure. As shown in FIG. 7, the method includes:
701: receiving indication information, the indication information including information on activation and/or deactivation and/or handover of a direct path, and/or, including information on activation and/or deactivation and/or handover of an indirect path; and
702: performing activation and/or deactivation and/or handover of the direct path, and/or performing activation and/or deactivation and/or handover of the indirect path, according to the indication information.

It should be noted that FIG. 7 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 7.

According to the above embodiment, the remote user equipment may receive the indication information, and perform activation and/or deactivation and/or handover of the direct path and/or perform activation and/or deactivation and/or handover of the indirect path. Hence, in a multi-path scheme, activation and/or deactivation and/or handover may be performed on the paths of the remote user equipment, which is conducive to dynamically adjusting the use of the paths in multiple paths, and improvement of reliability and rate of data transmission of the remote UE.

In the embodiments of this disclosure, the direct path and/or the indirect path may be activated.

A direct path to be activated may be a configured direct path between the remote user equipment and the network device, which may be in an inactive state or a just configured state; however, this disclosure is not limited thereto, and the direct path to be activated may also be a path that is in an active state. Therefore, with the above indication information, the direct path may be newly activated or activated again between the remote user equipment and the network device.

An indirect path to be activated may be a configured indirect path between the remote user equipment and the network device, which may be in an inactive state or a just configured state; however, this disclosure is not limited thereto, and the indirect path to be activated may also be a path that is in an active state. Therefore, with the above indication information, the indirect path may be newly activated or activated again between the remote user equipment and the network device.

In some embodiments, in activating a direct path, there may exist an indirect path between the remote user equipment and the network device, hence, the indication information may be transmitted via the indirect path.

In some embodiments, in activating an indirect path, there may exist a direct path between the remote user equipment and the network device, hence, the indication information may be transmitted via the direct path.

In the embodiment of this disclosure, the direct path and/or the indirect path may be deactivated.

After the direct path is deactivated, the remote user equipment and the network device may reserve configuration of the direct path in the inactive state, so as to activate the direct path via the above indication information in a subsequent communication process, and quickly recover the direct path. However, this disclosure is not limited thereto, and the remote user equipment and the network device may not reserve the configuration of the direct path in the inactive state, and the direct path may be reconfigured via configuration information of the network device.

After deactivating the indirect path, the remote user equipment and the network device may reserve configuration of the indirect path in the inactive state, so as to activate the indirect path via the above indication information in a subsequent communication process, and quickly recover the indirect path. However, this disclosure is not limited thereto, and the remote user equipment and the network device may not reserve the configuration of the indirect path in the inactive state, and the indirect path may be reconfigured via configuration information of the network device.

In some embodiments, in deactivating the direct path, there may exist an indirect path between the remote user equipment and the network device in addition to the direct path, and the indirect path may be in an active or inactive state. Or, in deactivating the direct path, there may exist no indirect path between the remote user equipment and the network device, for example, no indirect path is configured.

In some embodiments, in deactivating the indirect path, there may exist a direct path between the remote user equipment and the network device in addition to the indirect path, and the direct path may be in an active or inactive state. Or, in deactivating the indirect path, there may exist no direct path between the remote user equipment and the network device, for example, no direct path is configured.

In the embodiment of this disclosure, handover may be performed in the direct path and/or indirect path.

Handover of a direct path or handover of in indirect path may be at least one of the following: handover from a direct path to an indirect path, or handover from an indirect path to a direct path, or handover from multiple paths (direct paths and indirect paths) to direct paths, or handover from multiple paths (direct paths and indirect paths) to indirect paths, or handover from direct paths to multiple paths (direct paths and indirect paths), or handover from indirect paths to multiple paths (direct paths and indirect paths), and so on.

In some embodiments, activation and/or deactivation and/or handover may be dynamically performed on the direct path and/or the indirect path according to channel state information. Thus, it is conducive to dynamically selecting paths of better quality and/or lower latency for communication, thereby saving radio resources of the Uu interface and/or the PC5 interface and/or reducing data transmission latency. However, this disclosure is not limited thereto, and activation and/or deactivation and/or handover may be performed on the direct path and/or the indirect path according to other indicators.

In some embodiments, more than one transmission modes may be used in the direct path and the indirect path.

For example, a split transmission mode may be used in the direct path and the indirect path. For example, for all radio bearers or one radio bearer of the remote user equipment, the network device may configure that the split transmission mode is used in the direct path and the indirect path. In this case, the direct path and the indirect path may transmit different data, such as different PDCP PDUs, thereby increasing throughput.

For example, a part of the PDCP PDUs may be transmitted in all RLC entities and/or logical channels corresponding to the RB and included in the direct path, and another part of the PDCP PDUs may be transmitted in all RLC entities and/or logical channels corresponding to the RB and included in the indirect path.

For another example, a part of the PDCP PDUs may be transmitted in one or more RLC entities and/or logical channels corresponding to the RB and included in the direct path, another part of the PDCP PDUs may be transmitted in another one or more than one RLC entities and/or logical channels corresponding to the RB and included in the direct path, and a further part of the PDCP PDUs may be transmitted in all RLC entities and/or logical channels corresponding to the RB and included in the indirect path.

For a further example, a part of the PDCP PDUs may be transmitted in all RLC entities and/or logical channels corresponding to the RB and included in the direct path, another part of the PDCP PDUs may be transmitted in one or more than one RLC entities and/or logical channels corresponding to the RB and included in the indirect path, and a further part of the PDCP PDUs may be transmitted in another one or more RLC entities and/or logical channels corresponding to the RB and included in the indirect path.

For still another example, a part of the PDCP PDUs may be transmitted in one or more RLC entities and/or logical channels corresponding to the RB and included in the direct path, another part of the PDCP PDUs may be transmitted in another one or more RLC entities and/or logical channels corresponding to the RB and included in the direct path, a further part of the PDCP PDUs may be transmitted in one or more RLC entities and/or logical channels corresponding to the RB and included in the indirect path, and still another part of the PDCP PDUs may be transmitted in further one or more RLC entities and/or logical channels corresponding to the RB and included in the indirect path, and so on.

For example, a duplication transmission mode may be used in the direct path and the indirect path. For example, for all radio bearers or one radio bearer of the remote user equipment, the network device may configure that the duplication transmission mode is used in the direct path and the indirect path. In this case, the direct path and the indirect path may transmit identical data, such as identical PDCP PDUs, and these identical PDCP PDUs may also be transmitted in all RLC entities and/or logical channels corresponding to the RB and included in the direct path and all RLC entities and/or logical channels corresponding to the RB and included in the indirect path. Thus, reliability of data transmission of the remote user equipment may be ensured.

In some embodiments, the network device and/or the remote user equipment may dynamically select transmission modes of the direct path and the indirect path according to channel state information, and service type information, etc., which is conducive to increasing the throughput of the communication system and ensuring quality of data transmission; however, this disclosure is not limited thereto, and a transmission mode may also be selected according to other indicators.

In some embodiments, the remote user equipment may receive indication information transmitted by the network device, for example, the remote user equipment may receive the indication information via a direct path. Or, the remote user equipment may receive indication information transmitted by the relay user equipment, for example, the remote user equipment receives the indication information via a PC5 interface or sidelink.

For ease of description, the indication information transmitted by the network device is referred to as first indication information, and the indication information transmitted by the relay user equipments is referred to as third indication information.

In some embodiments, the first indication information may include at least one of the following:
a data radio bearer (DRB) identity, a path identity or index, a logical channel identity (LCID) or index, a radio link control (RLC) entity (or bearer or channel) identity or index, path usage indication information, or path state indication information. That is, the first indication information may be one piece of the above information or a combination thereof.

In some embodiments, the DRB identity in the first indication information may be a DRB identity corresponding to the path to be activated/handed over, or, the DRB identity may be a DRB identity corresponding to the path to be deactivated. After receiving the DRB identity, the remote user equipment may perform activation and/or deactivation and/or handover on a corresponding path according to the DRB identity and a corresponding correlation between the DRB identity and the path.

In some embodiments, the first indication information transmitted by the network device to the remote user equipment may include indication information for the direct path, or indication information for the indirect path, or indication information for both the direct path and the indirect path. In the first indication information, the direct path and the indirect path may be distinguished by the path identity or index. The remote user equipment may receive via the direct path information transmitted by the network device for performing deactivation/handover on the direct path itself, or may receive via the direct path information for performing activation/deactivation/handover on the indirect path.

In some embodiments, the logical channel identity or index or RLC entity (or bearer or channel) identity or index is used for: activating or deactivating a radio link control entity and/or a logical channel in a case where use of more than one RLC entities and/or logical channel transmissions by a radio bearer is supported on a PC5 interface of the indirect path.

In some embodiments, the path usage indication information may be information indicating use of split transmission or duplication transmission between the direct path and the indirect path.

In some embodiments, the path state indication information may be information indicating performing activation and/or deactivation and/or handover on the direct path and/or the indirect path.

In some embodiments, the first indication information may indicate via a bitmap an active or inactive state of the path to which the DRB identity or index corresponds. Hence, signaling overhead may be reduced.

FIG. 8 is a schematic diagram of a bitmap of the embodiment of the first aspect of this disclosure. As shown in FIG. 8, the bitmap may be used to indicate an active or inactive state of the direct path and/or the indirect path corresponding to the DRB. For example, taking the direct path as an example, in a case where the direct path may be used for data transmission of n DRBs, active or inactive states of paths to which DRB indices 0 to n-1 correspond are respectively indicated by bitmaps (b₀, b₁, . . . bᵢ, . . . bₙ₋₁) (where, n is greater than or equal to 1, i is greater than or equal to 0 and less than or equal to n), or, active or inactive states of paths to which DRB indices n-1 to 0 correspond are respectively indicated by bitmaps (bₙ₋₁, bₙ₋₂ . . . bᵢ, . . . b₀), wherein the DRB indices are ranked in an ascending or descending order of the DRB IDs. Taking bitmaps (b₀, b₁, . . . bᵢ, . . . bₙ₋₁) as an example, in a case where the remote user equipment receives the bitmaps from a direct path and one bit in the bitmaps indicates activation, a direct path of a DRB to which the bit corresponds is activated; and in a bit in the bitmaps indicates deactivation, a direct path of a DRB to which the bit corresponds is deactivated. A method for determining activation and deactivation of the indirect paths is similar to that of the direct path, which shall not be described herein any further. However, this disclosure is not limited thereto, and other forms of bitmaps may also be used to indicate an active or inactive state of a path. In some embodiments, the first indication information may be transmitted via a radio resource control (RRC) message or a packet data convergence protocol (PDCP) control packet data unit (PDU) or a media access control (MAC) control element (CE). However, this disclosure is not limited thereto, and the first indication information may also be transmitted in other means.

In some embodiments, the third indication information transmitted by the relay user equipment may include at least one of the following:
a DRB identity, a logical channel identity (LCID) or index, an RLC entity (or bearer or channel) identity or index, or path state indication information. That is, the third indication information may be one piece of the above information or a combination thereof.

In some embodiments, the third indication information transmitted by the relay user equipment to the remote user equipment may include indication information for the indirect path. The remote user equipment may receive via the indirect path information for performing deactivation/handover on the indirect path itself. In the third indication information, information on the path identity or index may be omitted. Hence, signaling overhead may be reduced.

However, this disclosure is not limited thereto, and the third indication information transmitted by the relay user equipment to the remote user equipment may also include indication information for the direct path. The remote user equipment may receive via the indirect path information for performing activation/deactivation/handover on the direct path.

In some embodiments, the DRB identity in the third indication information may be a DRB identity corresponding to the path to be activated/handed over, or the DRB identity may be a DRB identity corresponding to the path to be deactivated. After receiving the DRB identity, the remote user equipment may perform activation and/or deactivation and/or handover on a corresponding path according to the DRB identity, such as performing activation and/or deactivation and/or handover on PC5 connection between the relay user equipment and the remote user equipment.

In some embodiments, the logical channel identity or index or the RLC entity (or bearer or channel) identity or index in the third indication information is used for: activating or deactivating an RLC entity (or bearer or channel) and/or a logical channel in a case where use of more than one RLC entities and/or logical channel transmissions by a radio bearer is supported on a PC5 interface of the indirect path.

In some embodiments, the path state indication information in the third indication information may be information indicating performing activation and/or deactivation and/or handover on the direct path and/or the indirect path.

In some embodiments, the third indication information may be transmitted via a PC5 radio resource control (RRC) message or a PC5 sidelink relay adaptation protocol (SRAP) control packet data unit (PDU) or a PC5 media access control (MAC) control element (CE). However, this disclosure is not limited thereto, and the third indication information may also be transmitted in other means.

In some embodiments, the third indication information may indicate via a bitmap an active or inactive state of a path to which the DRB identity or index corresponds. Hence, signaling overhead may be reduced.

In some embodiments, the third indication information transmitted by the relay user equipment may be information generated by the relay user equipment itself. Or, the third indication information may be information generated by the relay user equipment according to indication information transmitted by the network device (e.g. the indication information may be second indication information in an embodiment described later). In other words, the relay user equipment receives the indication information transmitted by the network device, and according to the indication information, generates the third indication information to be transmitted to the remote user equipment.

In some embodiments, the indication information transmitted by the network device to the relay user equipment may include at least one of the following: a DRB identity, a logical channel identity (LCID) or index, an RLC entity (or bearer or channel) identity or index, or path state indication information. Contents of the information in the indication information may be identical or similar to those of corresponding information in the above-described third indication information, which shall not be described herein any further. Or, the indication information may indicate via a bitmap an active or inactive state of a path to which the DRB identity or index corresponds.

In some embodiments, the indication information transmitted by the network device to the relay user equipment may be transmitted via an RRC message or a PDCP control PDU or an MAC CE. However, this disclosure is not limited thereto, and the indication information may also be transmitted in other means.

In some embodiments, the remote user equipment may receive the first indication information transmitted by the network device or the third indication information transmitted by the relay user equipment, and perform activation and/or deactivation and/or handover on a path according to the first indication information or the third indication information. Or, the remote user equipment may receive the first indication information transmitted by the network device and the third indication information transmitted by the relay user equipment, and perform activation and/or deactivation and/or handover on a path according to the first indication information and the third indication information.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the steps related to this disclosure are described above; however, this disclosure is not limited thereto, and the method for transmitting failure information may further include other steps, and reference may be made to relevant techniques for contents of these steps.

It can be seen from the above embodiment that the remote user equipment may receive the indication information, and performs activation and/or deactivation and/or handover on the direct path according to the indication information, and/or, the remote user equipment may receive the indication information, and performs activation and/or deactivation and/or handover on the indirect path according to the indication information. Hence, in a multi-path scheme, activation and/or deactivation and/or handover may be performed on the paths of the remote user equipment, which is conducive to dynamically adjusting the use of the paths in multiple paths, and improvement of reliability and rate of data transmission of the remote UE.

### Embodiment of a Second Aspect

The embodiment of this disclosure provides a multi-path processing apparatus. The apparatus may be, for example, a remote user equipment (such as the remote user equipment 401 described above), or may be one or some components or assemblies configured in the remote user equipment, with contents identical to those in the embodiment of the first aspect being not going to be described herein any further.

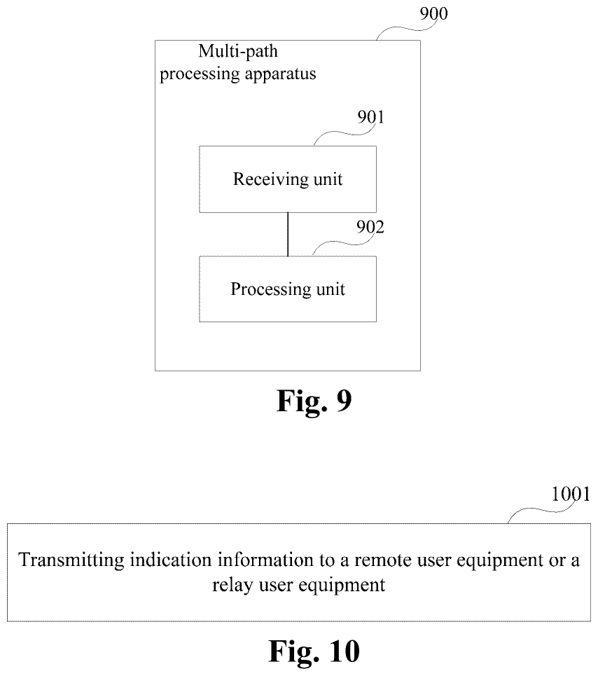

FIG. 9 is a schematic diagram of the multi-path processing apparatus of the embodiment of the second aspect of this disclosure. As shown in FIG. 9, a multi-path processing apparatus 900 includes:
a receiving unit 901 configured to receive indication information, the indication information including information on activation and/or deactivation and/or handover of a direct path, and/or, including information on activation and/or deactivation and/or handover of an indirect path; and
a processing unit 902 configured to perform activation and/or deactivation and/or handover of the direct path, and/or perform activation and/or deactivation and/or handover of the indirect path, according to the indication information.

In some embodiments, the indication information may include first indication information transmitted by a network device, wherein the first indication information includes at least one of the following:
a data radio bearer (DRB) identity, a path identity or index, a logical channel identity (LCID) or index, a radio link control (RLC) entity (or bearer or channel) identity or index, path usage indication information, or path state indication information.

In some embodiments, the logical channel identity or index or the radio link control entity (bearer or channel) identity or index is used for: activating or deactivating a radio link control entity (bearer or channel) and/or a logical channel in a case where use of more than one radio link control entities (bearers or channels) and/or logical channel transmissions by a radio bearer is supported on a PC5 interface of the indirect path.

In some embodiments, the indication information includes first indication information transmitted by the network device, the first indication information indicating via a bitmap an active or inactive state of the path to which the data radio bearer identity or index corresponds.

In some embodiments, the first indication information is transmitted via a radio resource control (RRC) message or a packet data convergence protocol (PDCP) control packet data unit (PDU) or a media access control (MAC) control element (CE).

In some embodiments, the indication information includes third indication information transmitted by the relay user equipment, the third indication information including at least one of the following:
a DRB identity, a logical channel identity (LCID) or index, an RLC entity (or bearer or channel) identity or index, or path state indication information (such as activation, and deactivation).

In some embodiments, the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

In some embodiments, the indication information includes third indication information transmitted by the relay user equipment, the third indication information indicating via a bitmap an active or inactive state of a path to which the DRB identity or index corresponds.

In some embodiments, the third indication information may be transmitted via a PC5 radio resource control (RRC) message or a PC5 sidelink relay adaptation protocol (SRAP) control packet data unit (PDU) or a PC5 media access control (MAC) control element (CE).

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 900 may further include other components or modules, and reference may be made to related techniques for particulars of these components or modules.

Furthermore, for the sake of simplicity, connection relationships between the components or modules or signal profiles thereof are only illustrated in FIG. 9. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the remote user equipment may receive the indication information, and performs activation and/or deactivation and/or handover on the direct path according to the indication information, and/or, the remote user equipment may receive the indication information, and performs activation and/or deactivation and/or handover on the indirect path according to the indication information. Hence, in a multi-path scheme, activation and/or deactivation and/or handover may be performed on the paths of the remote user equipment, which is conducive to dynamically adjusting the use of the paths in multiple paths, and improvement of reliability and rate of data transmission of the remote UE.

### Embodiment of a Third Aspect

The embodiment of this disclosure provides a multi-path processing method, which may be carried out in a network device (such as the network device 403 described above), with contents identical to those in the embodiment of the first aspect being not going to be described herein any further.

FIG. 10 is a schematic diagram of the multi-path processing method of the embodiment of the third aspect of this disclosure. As shown in FIG. 10, the method includes:
1001: transmitting indication information to a remote user equipment or a relay user equipment, wherein the indication information includes information on activation and/or deactivation and/or handover of a direct path, and/or, includes information on activation and/or deactivation and/or handover of an indirect path.

It should be noted that FIG. 10 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 10.

According to the above embodiment, the network device transmits the indication information to the remote user equipment and/or the relay user equipment, so that the remote user equipment and/or the relay user equipment perform(s) activation and/or deactivation and/or handover of the direct path and/or perform activation and/or deactivation and/or handover of the indirect path according to the indication information. Hence, in a multi-path scheme, activation and/or deactivation and/or handover may be performed on the paths, which is conducive to dynamically adjusting the use of the paths in multiple paths, and improvement of reliability and rate of data transmission of the remote UE.

In some embodiments, the indication information may include first indication information transmitted to the remote user equipment, wherein the first indication information includes at least one of the following:
a data radio bearer (DRB) identity, a path identity or index, a logical channel identity (LCID) or index, a radio link control (RLC) entity (or bearer or channel) identity or index, path usage indication information, or path state indication information.

In some embodiments, the logical channel identity or index or the radio link control entity (bearer or channel) identity or index is used for: activating or deactivating a radio link control entity (bearer or channel) and/or a logical channel in a case where use of more than one radio link control entities (bearers or channels) and/or logical channel transmissions by a radio bearer is supported on a PC5 interface of the indirect path.

In some embodiments, the indication information may include first indication information transmitted to the remote user equipment, the first indication information indicating via a bitmap an active or inactive state of the path to which the data radio bearer identity or index corresponds.

In some embodiments, the first indication information is transmitted via a radio resource control (RRC) message or a packet data convergence protocol (PDCP) control packet data unit (PDU) or a media access control (MAC) control element (CE).

In some embodiments, the indication information may include second indication information transmitted to the remote user equipment, the second indication information including at least one of the following:
a data radio bearer (DRB) identity, a logical channel identity (LCID) or index, a radio link control (RLC) entity (or bearer or channel) identity or index, or path state indication information.

In some embodiments, the logical channel identity or index or RLC entity (or bearer or channel) identity or index is used for: activating or deactivating a radio link control entity and/or a logical channel in a case where use of more than one RLC entities and/or logical channel transmissions by a radio bearer is supported on a PC5 interface of the indirect path.

In some embodiments, the indication information includes second indication information transmitted to the relay user equipment, the second indication information indicating via a bitmap an active or inactive state of the path to which the DRB identity or index corresponds.

In some embodiments, the second indication information is transmitted via a radio resource control (RRC) message or a packet data convergence protocol (PDCP) control packet data unit (PDU) or a media access control (MAC) control element (CE).

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the steps related to this disclosure are described above; however, this disclosure is not limited thereto, and the method for transmitting failure information may further include other steps, and reference may be made to relevant techniques for contents of these steps.

It can be seen from the above embodiment that the network device transmits the indication information to the remote user equipment and/or the relay user equipment, so that the remote user equipment and/or the relay user equipment perform(s) activation and/or deactivation and/or handover of the direct path and/or perform activation and/or deactivation and/or handover of the indirect path according to the indication information. Hence, in a multi-path scheme, activation and/or deactivation and/or handover may be performed on the paths, which is conducive to dynamically adjusting the use of the paths in multiple paths, and improvement of reliability and rate of data transmission of the remote UE.

### Embodiment of a Fourth Aspect

The embodiment of this disclosure provides a multi-path processing apparatus. The apparatus may be, for example, a network device (such as the network device 403 described above), or may be one or some components or assemblies configured in the network device, with contents identical to those in the embodiment of the third aspect being not going to be described herein any further.

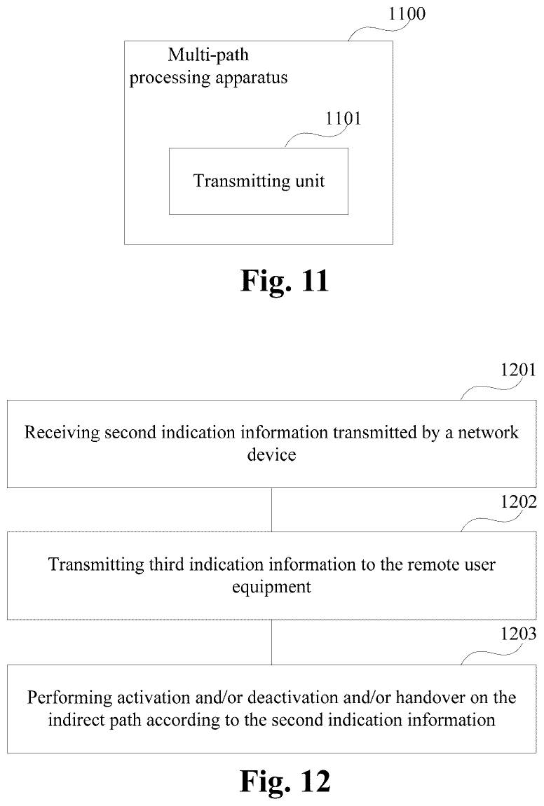

FIG. 11 is a schematic diagram of the multi-path processing apparatus of the embodiment of the third aspect of this disclosure. As shown in FIG. 11, a multi-path processing apparatus 1100 includes:
a transmitting unit 1101 configured to transmit indication information to a remote user equipment or a relay user equipment, wherein the indication information includes information on activation and/or deactivation and/or handover of a direct path, and/or, includes information on activation and/or deactivation and/or handover of an indirect path.

In some embodiments, the indication information may include first indication information transmitted to the remote user equipment, wherein the first indication information includes at least one of the following:
a data radio bearer (DRB) identity, a path identity or index, a logical channel identity (LCID) or index, a radio link control (RLC) entity (or bearer or channel) identity or index, path usage indication information, or path state indication information.

In some embodiments, the logical channel identity or index or the radio link control entity (bearer or channel) identity or index is used for: activating or deactivating a radio link control entity (bearer or channel) and/or a logical channel in a case where use of more than one radio link control entities (bearers or channels) and/or logical channel transmissions by a radio bearer is supported on a PC5 interface of the indirect path.

In some embodiments, the indication information may include first indication information transmitted to the remote user equipment, the first indication information indicating via a bitmap an active or inactive state of the path to which the data radio bearer identity or index corresponds.

In some embodiments, the first indication information is transmitted via an RRC message or a PDCP control PDU or an MAC CE.

In some embodiments, the indication information includes second indication information transmitted to the relay user equipment, the second indication information including at least one of the following:
a data radio bearer (DRB) identity, a logical channel identity (LCID) or index, a radio link control (RLC) entity (or bearer or channel) identity or index, or path state indication information.

In some embodiments, the logical channel identity or index or RLC entity (or bearer or channel) identity or index is used for: activating or deactivating a radio link control entity and/or a logical channel in a case where use of more than one RLC entities and/or logical channel transmissions by a radio bearer is supported on a PC5 interface of the indirect path.

In some embodiments, the indication information includes second indication information transmitted to the relay user equipment, the second indication information indicating via a bitmap an active or inactive state of the path to which the DRB identity or index corresponds.

In some embodiments, the second indication information is transmitted via an RRC message or a PDCP control PDU or an MAC CE.

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1100 may further include other components or modules, and reference may be made to related techniques for particulars of these components or modules.

Furthermore, for the sake of simplicity, connection relationships between the components or modules or signal profiles thereof are only illustrated in FIG. 11. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the network device transmits the indication information to the remote user equipment and/or the relay user equipment, so that the remote user equipment and/or the relay user equipment perform(s) activation and/or deactivation and/or handover of the direct path and/or perform activation and/or deactivation and/or handover of the indirect path according to the indication information. Hence, in a multi-path scheme, activation and/or deactivation and/or handover may be performed on the paths, which is conducive to dynamically adjusting the use of the paths in multiple paths, and improvement of reliability and rate of data transmission of the remote UE.

### Embodiment of a Fifth Aspect

The embodiment of this disclosure provides a multi-path processing method, which may be carried out in a relay user equipment (such as the relay user equipment 402 described above), with contents identical to those in the embodiments of the first and third aspects being not going to be described herein any further.

FIG. 12 is a schematic diagram of the multi-path processing method of the embodiment of the fifth aspect of this disclosure. As shown in FIG. 12, the method includes:
1201: receiving second indication information transmitted by a network device. The second indication information may include information on activation and/or deactivation and/or handover of an indirect path.

It should be noted that FIG. 12 only schematically illustrates the embodiment of this disclosure; however, this disclosure is not limited thereto. For example, an order of execution of the steps may be appropriately adjusted, and furthermore, some other steps may be added, or some steps therein may be reduced. And appropriate variants may be made by those skilled in the art according to the above contents, without being limited to what is contained in FIG. 12.

It can be seen from the above embodiment that the relay user equipment may receive the second indication information for performing activation and/or deactivation and/or handover on the path. Therefore, in a multi-path scheme, it is conducive to the relay user equipment to learn a current path state, so as to perform corresponding operations. For example, when an indirect path of the remote user equipment is deactivated, the relay user equipment may also deactivate relevant processing of a PC5 interface and/or deactivate an indirect path corresponding to the remote user equipment in the Uu interface, thereby saving power consumption of the relay user equipment.

In some embodiments, the multi-path processing method may further include:
1202: transmitting third indication information to the remote user equipment after the second indication information is received.

The third indication information may include information on activation and/or deactivation and/or handover of the indirect path.

By transmitting the third indication information to the remote user equipment, the remote user equipment is made to perform activation and/or deactivation and/or handover on the indirect path.

In some embodiments, the multi-path processing method may further include:
1203: performing activation and/or deactivation and/or handover on the indirect path according to the second indication information.

Thus, the relay user equipment itself may perform activation and/or deactivation and/or handover on the indirect path.

In some embodiments, after receiving the second indication information, the relay user equipment may activate the PC5 connection between the relay user equipment and the remote user equipment according to the second indication information, or deactivate the PC5 connection, or deactivate connection corresponding to the remote user equipment between the relay user equipment and the network device, and so on.

In some embodiments, after processing of the indirect path is completed, the relay user equipment may notify the remote user equipment of a result of processing the indirect path. Thus, the remote user equipment may be made to communicate with the network device on a corresponding path according to the result of processing.

In some embodiments, the second indication information and/or the third indication information include(s) at least one of the following:
a data radio bearer (DRB) identity, a logical channel identity (LCID) or index, a radio link control (RLC) entity (or bearer or channel) identity or index, or path state indication information.

In some embodiments, the logical channel identity or index or the radio link control entity (bearer or channel) identity or index is used for: activating or deactivating a radio link control entity (bearer or channel) and/or a logical channel in a case where use of more than one radio link control entities (bearers or channels) and/or logical channel transmissions by a radio bearer is supported on a PC5 interface of the indirect path.

In some embodiments, the second indication information includes the DRB identity, and the relay user equipment determines to activate or deactivate an RLC entity (or bearer or channel) and/or a logical channel of a Uu interface of a DRB according to the DRB identity in the second indication information, and/or activate or deactivate an RLC entity (or bearer or channel) and/or a logical channel of a PC5 interface of a DRB.

In some embodiments, the second indication information includes an RLC entity (or bearer or channel) and/or logical channel identity or index, and the relay user equipment determines to activate or deactivate the RLC entity (or bearer or channel) and/or logical channel of the Uu interface of the DRB and/or activate or deactivate an RLC entity (or bearer or channel) and/or logical channel of a PC5 interface of a DRB according to the RLC entity (or bearer or channel) and/or logical channel identity or index in the second indication information.

In some embodiments, the second indication information includes path state indication information, and the relay user equipment determines to perform activation or deactivation or handover on the remote user equipment and/or the DRB of the remote user equipment and/or the RLC entity (or bearer or channel) and/or logical channel of the DRB of the remote user equipment according to the path state indication information in the second indication information.

In some embodiments, the second indication information and/or the third indication information indicate(s) via a bitmap an active or inactive state of the path to which the DRB identity or index corresponds.

In some embodiments, the second indication information is transmitted via a radio resource control (RRC) message or a packet data convergence protocol (PDCP) control packet data unit (PDU) or a media access control (MAC) control element (CE); and/or
the third indication information is transmitted via a PC5 radio resource control (RRC) message or a PC5 sidelink relay adaptation protocol (SRAP) control packet data unit (PDU) or a PC5 media access control (MAC) control element (CE).

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the steps related to this disclosure are described above; however, this disclosure is not limited thereto, and the method for transmitting failure information may further include other steps, and reference may be made to relevant techniques for contents of these steps.

It can be seen from the above embodiment that the relay user equipment may receive the second indication information for performing activation and/or deactivation and/or handover. Hence, in a multi-path scheme, activation and/or deactivation and/or handover may be performed on the paths between the remote user equipment and the network device, which is conducive to dynamically adjusting the use of the paths in multiple paths, and improvement of reliability and rate of data transmission of the remote UE.

### Embodiment of a Sixth Aspect

The embodiment of this disclosure provides a multi-path processing apparatus. The apparatus may be, for example, a relay user equipment (such as the relay user equipment 402 described above), or may be one or some components or assemblies configured in the relay user equipment, with contents identical to those in the embodiment of the fifth aspect being not going to be described herein any further.

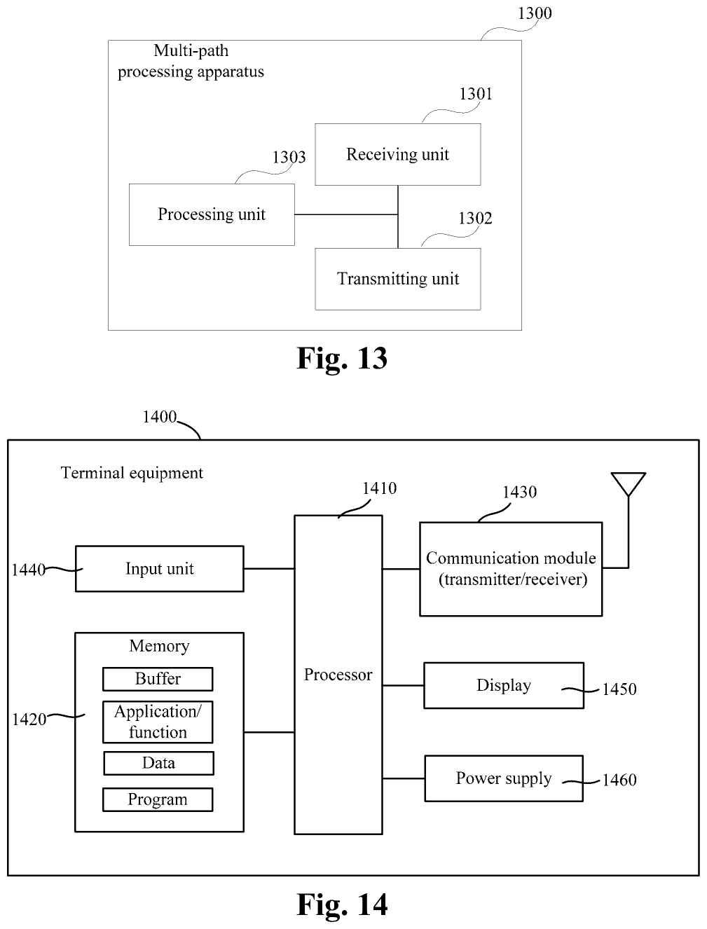

FIG. 13 is a schematic diagram of the multi-path processing apparatus of the embodiment of the sixth aspect of this disclosure. As shown in FIG. 13, a multi-path processing apparatus 1300 includes:
a receiving unit 1301 configured to receive second indication information transmitted by a network device.

The second indication information includes information on activation and/or deactivation and/or handover of an indirect path.

In some embodiments, the multi-path processing apparatus 1300 may further include:
a transmitting unit 1302 configured to transmit third indication information to the remote user equipment after the receiving unit 1301 receives the second indication information.

The third indication information may include information on activation and/or deactivation and/or handover of the indirect path.

In some embodiments, the multi-path processing apparatus 1300 may further include:
a processing unit 1303 configured to perform activation and/or deactivation and/or handover on the indirect path according to the second indication information.

In some embodiments, the second indication information and/or the third indication information include(s) at least one of the following:
a data radio bearer (DRB) identity, a logical channel identity (LCID) or index, a radio link control (RLC) entity (or bearer or channel) identity or index, or path state indication information.

In some embodiments, the logical channel identity or index or the radio link control entity (bearer or channel) identity or index is used for: activating or deactivating a radio link control entity (bearer or channel) and/or a logical channel in a case where use of more than one radio link control entities (bearers or channels) and/or logical channel transmissions by a radio bearer is supported on a PC5 interface of the indirect path.

In some embodiments, the second indication information and/or the third indication information indicate(s) via a bitmap an active or inactive state of the path to which the DRB identity or index corresponds.

In some embodiments, the second indication information is transmitted via a radio resource control (RRC) message or a packet data convergence protocol (PDCP) control packet data unit (PDU) or a media access control (MAC) control element (CE); and/or
the third indication information is transmitted via a PC5 radio resource control (RRC) message or a PC5 sidelink relay adaptation protocol (SRAP) control packet data unit (PDU) or a PC5 media access control (MAC) control element (CE).

The above implementations only illustrate the embodiment of this disclosure. However, this disclosure is not limited thereto, and appropriate variants may be made on the basis of these implementations. For example, the above implementations may be executed separately, or one or more of them may be executed in a combined manner.

It should be noted that the components or modules related to this disclosure are only described above. However, this disclosure is not limited thereto, and the multi-path processing apparatus 1300 may further include other components or modules, and reference may be made to related techniques for particulars of these components or modules.

Furthermore, for the sake of simplicity, connection relationships between the components or modules or signal profiles thereof are only illustrated in FIG. 13. However, it should be understood by those skilled in the art that such related techniques as bus connection, etc., may be adopted. And the above components or modules may be implemented by hardware, such as a processor, a memory, a transmitter, and a receiver, etc., which are not limited in the embodiment of this disclosure.

It can be seen from the above embodiment that the relay user equipment may receive the second indication information for performing activation and/or deactivation and/or handover. Hence, in a multi-path scheme, activation and/or deactivation and/or handover may be performed on the paths between the remote user equipment and the network device, which is conducive to dynamically adjusting the use of the paths in multiple paths, and improvement of reliability and rate of data transmission of the remote UE.

### Embodiment of a Seventh Aspect

The embodiment of this disclosure provides a communication system, and reference may be made to FIG. 4, with contents identical to those in the embodiments of the first to the sixth aspects being not going to be described herein any further.

In some embodiments, the communication system 400 may at least include: a remote user equipment 401 and/or a network device 403 and/or a relay user equipment 402.

In the embodiment of this disclosure, the remote user equipment 401 may be configured to carry out the multi-path processing method in the embodiment of the first aspect, the contents of which being incorporated herein, which shall not be described herein any further.

In the embodiment of this disclosure, the network device 403 may be configured to carry out the multi-path processing method in the embodiment of the third aspect, the contents of which being incorporated herein, which shall not be described herein any further.

In the embodiment of this disclosure, the relay user equipment 402 may be configured to carry out the multi-path processing method in the embodiment of the fifth aspect, the contents of which being incorporated herein, which shall not be described herein any further.

The embodiment of this disclosure further provides a terminal equipment.

FIG. 14 is a schematic diagram of a structure of the terminal equipment of the seventh aspect of the embodiments of this disclosure. The terminal equipment may be a remote user equipment or a relay user equipment. As shown in FIG. 14, a terminal equipment 1400 may include a processor 1410 and a memory 1420, the memory 1420 storing data and a program and being coupled to the processor 1410. It should be noted that this figure is illustrative only, and other types of structures may also be used, so as to supplement or replace this structure and achieve a telecommunications function or other functions.

For example, the processor 1410 may be configured to execute a program to carry out the multi-path processing method in the embodiment of the first aspect. For example, the processor 1410 may be configured to executed the following operation: receiving indication information, the indication information including information on activation and/or deactivation and/or handover of a direct path, and/or, including information on activation and/or deactivation and/or handover of an indirect path; and performing activation and/or deactivation and/or handover of the direct path, and/or performing activation and/or deactivation and/or handover of the indirect path, according to the indication information.

For another example, the processor 1410 may be configured to execute a program to carry out the multi-path processing method in the embodiment of the fifth aspect. For example, the processor 1410 may be configured to executed the following operation: receiving second indication information transmitted by a network device, the second indication information including information on activation and/or deactivation and/or handover of an indirect path.

As shown in FIG. 14, the terminal equipment 1400 may further include a communication module 1430, an input unit 1440, a display 1450, and a power supply 1460, wherein functions of the above components are similar to those in the related art, which shall not be described herein any further. It should be noted that the terminal equipment 1400 does not necessarily include all the parts shown in FIG. 14, and the above components are not necessary. Furthermore, the terminal equipment 1400 may include parts not shown in FIG. 14, and the related art may be referred to.

The embodiment of this disclosure further provides a network device, which may be, for example, a base station. However, this disclosure is not limited thereto, and it may also be another network device.

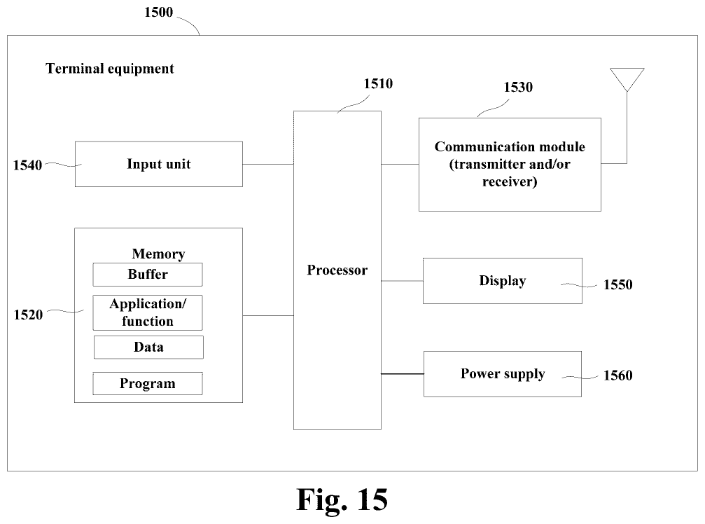

FIG. 15 is a schematic diagram of a structure of the network device of the embodiment of the seventh aspect of this disclosure. As shown in FIG. 15, a network device 1500 may include a processor 1510 (such as a central processing unit (CPU)) and a memory 1520, the memory 1520 being coupled to the processor 1510. The memory 1520 may store various data, and furthermore, it may store a program 1530 for information processing, and execute the program 1530 under control of the processor 1510.

For example, the processor 1510 may be configured to execute the following operation: transmitting indication information to a remote user equipment or a relay user equipment, wherein the indication information includes information on activation and/or deactivation and/or handover of a direct path, and/or, includes information on activation and/or deactivation and/or handover of an indirect path.

Furthermore, as shown in FIG. 15, the network device 1500 may include a transceiver 1540, and an antenna 1550, etc. Functions of the above components are similar to those in the related art, and shall not be described herein any further. It should be noted that the network device 1500 does not necessarily include all the parts shown in FIG. 15, and furthermore, the network device 1500 may include parts not shown in FIG. 15, and the related art may be referred to.

It can be seen from the above embodiment that the remote user equipment may receive the indication information, and perform activation and/or deactivation and/or handover of the direct path and/or perform activation and/or deactivation and/or handover of the indirect path. Hence, in a multi-path scheme, activation and/or deactivation and/or handover may be performed on the paths of the remote user equipment, which is conducive to dynamically adjusting the use of the paths in multiple paths, and improvement of reliability and rate of data transmission of the remote UE.

An embodiment of this disclosure provides a computer readable program, which, when executed in a remote user equipment, causes a computer to carry out the multi-path processing method as described in the embodiments of the first aspect in the remote user equipment.

An embodiment of this disclosure provides a computer storage medium, including a computer readable program, which causes a computer to carry out the multi-path processing method as described in the embodiment of the first aspect in a remote user equipment.

An embodiment of this disclosure provides a computer readable program, which, when executed in a relay user equipment, causes a computer to carry out the multi-path processing method as described in the embodiment of the fifth aspect in the relay user equipment.

An embodiment of this disclosure provides a computer storage medium, including a computer readable program, which causes a computer to carry out the multi-path processing method as described in the embodiment of the fifth aspect in a relay user equipment.

An embodiment of this disclosure provides a computer readable program, which, when executed in a network device, causes a computer to carry out the multi-path processing method as described in the embodiment of the third aspect in the network device.

An embodiment of this disclosure provides a computer storage medium, including a computer readable program, which causes a computer to carry out the multi-path processing method as described in the embodiment of the third aspect in a network device.

The above apparatuses and methods of this disclosure may be implemented by hardware, or by hardware in combination with software. This disclosure relates to such a computer-readable program that when the program is executed by a logic device, the logic device is enabled to carry out the apparatus or components as described above, or to carry out the methods or steps as described above. This disclosure also relates to a storage medium for storing the above program, such as a hard disk, a floppy disk, a CD, a DVD, and a flash memory, etc.

The methods/apparatuses described with reference to the embodiments of this disclosure may be directly embodied as hardware, software modules executed by a processor, or a combination thereof. For example, one or more functional block diagrams and/or one or more combinations of the functional block diagrams shown in the drawings may either correspond to software modules of procedures of a computer program, or correspond to hardware modules. Such software modules may respectively correspond to the steps shown in the drawings. And the hardware module, for example, may be carried out by firming the soft modules by using a field programmable gate array (FPGA).

The soft modules may be located in an RAM, a flash memory, an ROM, an EPROM, an EEPROM, a register, a hard disc, a floppy disc, a CD-ROM, or any memory medium in other forms known in the art. A memory medium may be coupled to a processor, so that the processor may be able to read information from the memory medium, and write information into the memory medium; or the memory medium may be a component of the processor. The processor and the memory medium may be located in an ASIC. The soft modules may be stored in a memory of a mobile terminal, and may also be stored in a memory card of a pluggable mobile terminal. For example, if equipment (such as a mobile terminal) employs an MEGA-SIM card of a relatively large capacity or a flash memory device of a large capacity, the soft modules may be stored in the MEGA-SIM card or the flash memory device of a large capacity.

One or more functional blocks and/or one or more combinations of the functional blocks in the drawings may be realized as a universal processor, a digital signal processor (DSP), an application-specific integrated circuit (ASIC), a field programmable gate array (FPGA) or other programmable logic devices, discrete gate or transistor logic devices, discrete hardware component or any appropriate combinations thereof carrying out the functions described in this application. And the one or more functional block diagrams and/or one or more combinations of the functional block diagrams in the drawings may also be realized as a combination of computing equipment, such as a combination of a DSP and a microprocessor, multiple processors, one or more microprocessors in communication combination with a DSP, or any other such configuration.

This disclosure is described above with reference to particular embodiments. However, it should be understood by those skilled in the art that such a description is illustrative only, and not intended to limit the protection scope of this disclosure. Various variants and modifications may be made by those skilled in the art according to the principle of this disclosure, and such variants and modifications fall within the scope of this disclosure.

As to implementations containing the above embodiments, following supplements are further disclosed.

1. A multi-path processing apparatus, applicable to a remote user equipment and including:
a receiving unit configured to receive indication information, the indication information including information on activation and/or deactivation and/or handover of a direct path, and/or, including information on activation and/or deactivation and/or handover of an indirect path; and
a processing unit configured to perform activation and/or deactivation and/or handover of the direct path, and/or perform activation and/or deactivation and/or handover of the indirect path, according to the indication information.

2. The apparatus according to supplement 1, wherein,
the indication information includes first indication information transmitted by a network device, the first indication information including at least one of the following:
a data radio bearer (DRB) identity, a path identity or index, a logical channel identity (LCID) or index, a radio link control (RLC) entity (or bearer or channel) identity or index, path usage indication information, or path state indication information.

3. The apparatus according to supplement 2, wherein,
the logical channel identity or index or RLC entity (or bearer or channel) identity or index is used for: activating or deactivating a radio link control entity and/or a logical channel in a case where use of more than one RLC entities (or bearers or channels) and/or logical channel transmissions by a radio bearer is supported on a PC5 interface of the indirect path.

4. The apparatus according to supplement 1, wherein,
the indication information includes first indication information transmitted by the network device, the first indication information indicating via a bitmap an active or inactive state of the path to which the DRB identity i or index i corresponds.

5. The apparatus according to any one of supplements 2-4, wherein,
the first indication information is transmitted via a radio resource control (RRC) message or a packet data convergence protocol (PDCP) control packet data unit (PDU) or a media access control (MAC) control element (CE).

6. The apparatus according to supplement 1, wherein,
the indication information includes third indication information transmitted by a relay user equipment, the third indication information including at least one of the following:
a data radio bearer (DRB) identity, a logical channel identity (LCID) or index, a radio link control (RLC) entity (or bearer or channel) identity or index, or path state indication information.

7. The apparatus according to supplement 6, wherein,
the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

8. The apparatus according to supplement 1, wherein,
the indication information includes third indication information transmitted by the relay user equipment, the third indication information indicating via a bitmap an active or inactive state of a path to which the DRB identity or index corresponds.

9. The apparatus according to any one of supplements 6-8, wherein,
the third indication information is transmitted via a PC5 radio resource control (RRC) message or a PC5 sidelink relay adaptation protocol (SRAP) control packet data unit (PDU) or a PC5 media access control (MAC) control element (CE).

10. A multi-path processing method, applicable to a remote user equipment and including:
receiving indication information, the indication information including information on activation and/or deactivation and/or handover of a direct path, and/or, including information on activation and/or deactivation and/or handover of an indirect path; and
performing activation and/or deactivation and/or handover of the direct path, and/or performing activation and/or deactivation and/or handover of the indirect path, according to the indication information.

11. The method according to supplement 10, wherein,
the indication information includes first indication information transmitted by a network device, the first indication information including at least one of the following:
a data radio bearer (DRB) identity, a path identity or index, a logical channel identity (LCID) or index, a radio link control (RLC) entity (or bearer or channel) identity or index, path usage indication information, or path state indication information.

12. The method according to supplement 11, wherein,
the logical channel identity or index or RLC entity (or bearer or channel) identity or index is used for: activating or deactivating a radio link control entity and/or a logical channel in a case where use of more than one RLC entities (or bearers or channels) and/or logical channel transmissions by a radio bearer is supported on a PC5 interface of the indirect path.

13. The method according to supplement 10, wherein,
the indication information includes first indication information transmitted by the network device, the first indication information indicating via a bitmap an active or inactive state of the path to which the DRB identity i or index i corresponds.

14. The method according to any one of supplements 11-13, wherein,
the first indication information is transmitted via a radio resource control (RRC) message or a packet data convergence protocol (PDCP) control packet data unit (PDU) or a media access control (MAC) control element (CE).

15. The method according to supplement 10, wherein,
the indication information includes third indication information transmitted by a relay user equipment, the third indication information including at least one of the following:
a data radio bearer (DRB) identity, a logical channel identity (LCID) or index, a radio link control (RLC) entity (or bearer or channel) identity or index, or path state indication information.

16. The method according to supplement 15, wherein,
the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

17. The method according to supplement 10, wherein,
the indication information includes third indication information transmitted by the relay user equipment, the third indication information indicating via a bitmap an active or inactive state of a path to which the DRB identity or index corresponds.

18. The method according to any one of supplements 15-17, wherein,
the third indication information is transmitted via a PC5 radio resource control (RRC) message or a PC5 sidelink relay adaptation protocol (SRAP) control packet data unit (PDU) or a PC5 media access control (MAC) control element (CE).

19. A remote user equipment, including a memory and a processor, the memory storing a computer program, and the processor being configured to execute the computer program to carry out the multi-path processing method as described in any one of supplements 10-18.

20. A multi-path processing apparatus, applicable to a network device and including:
a transmitting unit configured to transmit indication information to a remote user equipment or a relay user equipment, wherein the indication information includes information on activation and/or deactivation and/or handover of a direct path, and/or, includes information on activation and/or deactivation and/or handover of an indirect path.

21. The apparatus according to supplement 20, wherein,
the indication information includes first indication information transmitted to the remote user equipment, the first indication information including at least one of the following:
a data radio bearer (DRB) identity, a path identity or index, a logical channel identity (LCID) or index, a radio link control (RLC) entity (bearer or channel) identity or index, path usage indication information, or path state indication information.

22. The apparatus according to supplement 21, wherein,
the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

23. The apparatus according to supplement 20, wherein,
the indication information includes first indication information transmitted to the remote user equipment, the first indication information indicating via a bitmap an active or inactive state of the path to which the DRB identity i or index i corresponds.

24. The apparatus according to any one of supplements 21-23, wherein,
the first indication information is transmitted via a radio resource control (RRC) message or a packet data convergence protocol (PDCP) control packet data unit (PDU) or a media access control (MAC) control element (CE).

25. The apparatus according to supplement 20, wherein,
the indication information includes second indication information transmitted to the relay user equipment, the second indication information including at least one of the following:
a data radio bearer (DRB) identity, a logical channel identity (LCID) or index, a radio link control (RLC) entity (or bearer or channel) identity or index, or path state indication information.

26. The apparatus according to supplement 25, wherein,
the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

27. The apparatus according to supplement 20, wherein,
the indication information includes second indication information transmitted to the relay user equipment, the second indication information indicating via a bitmap an active or inactive state of the path to which the DRB identity i or index i corresponds.

28. The apparatus according to any one of supplements 25-27, wherein,
the second indication information is transmitted via a radio resource control (RRC) message or a packet data convergence protocol (PDCP) control packet data unit (PDU) or a media access control (MAC) control element (CE).

29. A multi-path processing method, applicable to a network device and including:
transmitting indication information to a remote user equipment or a relay user equipment, the indication information including information on activation and/or deactivation and/or handover of a direct path, and/or, including information on activation and/or deactivation and/or handover of an indirect path.

30. The method according to supplement 29, wherein,
the indication information includes first indication information transmitted to the remote user equipment, the first indication information including at least one of the following:
a data radio bearer (DRB) identity, a path identity or index, a logical channel identity (LCID) or index, a radio link control (RLC) entity (or bearer or channel) identity or index, path usage indication information, or path state indication information.

31. The method according to supplement 30, wherein,
the logical channel identity or index or the RLC entity (or bearer or channel) identity or index is used for: activating or deactivating an RLC entity (or bearer or channel) and/or a logical channel in a case where use of more than one RLC entities (or bearers or channels) and/or logical channel transmissions by a radio bearer is supported on a PC5 interface of the indirect path.

32. The method according to supplement 29, wherein,
the indication information includes first indication information transmitted to the remote user equipment, the first indication information indicating via a bitmap an active or inactive state of the path to which the DRB identity i or index i corresponds.

33. The method according to any one of supplements 30-32, wherein,
the first indication information is transmitted via a radio resource control (RRC) message or a packet data convergence protocol (PDCP) control packet data unit (PDU) or a media access control (MAC) control element (CE).

34. The method according to supplement 29, wherein,
the indication information includes second indication information transmitted to the relay user equipment, the second indication information including at least one of the following:
a data radio bearer (DRB) identity, a logical channel identity (LCID) or index, a radio link control (RLC) entity (or bearer or channel) identity or index, or path state indication information.

35. The method according to supplement 34, wherein,
the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

36. The method according to supplement 29, wherein,
the indication information includes second indication information transmitted to the relay user equipment, the second indication information indicating via a bitmap an active or inactive state of the path to which the DRB identity i or index i corresponds.

37. The method according to any one of supplements 34-36, wherein,
the second indication information is transmitted via a radio resource control (RRC) message or a packet data convergence protocol (PDCP) control packet data unit (PDU) or a media access control (MAC) control element (CE).

38. A network device, including a memory and a processor, the memory storing a computer program, and the processor being configured to execute the computer program to carry out the multi-path processing method as described in any one of supplements 29-37.

39. A multi-path processing apparatus, applicable to a relay user equipment and including:
a receiving unit configured to receive second indication information transmitted by a network device, the second indication information including information on activation and/or deactivation and/or handover of an indirect path.

40. The apparatus according to supplement 39, wherein the apparatus further includes:
a transmitting unit configured to transmit third indication information to a remote user equipment after the receiving unit receives the second indication information, the third indication information including information on activation and/or deactivation and/or handover of the indirect path.

41. The apparatus according to supplement 39 or 40, wherein the apparatus further includes:
a processing unit configured to perform activation and/or deactivation and/or handover of the indirect path according to the second indication information.

42. The apparatus according to supplement 40 or 41, wherein,
the second indication information and/or the third indication information include(s) at least one of the following:
a data radio bearer (DRB) identity, a logical channel identity (LCID) or index, a radio link control (RLC) entity (or bearer or channel) identity or index, or path state indication information.

43. The method according to supplement 42, wherein,
the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

44. The apparatus according to supplement 40 or 41, wherein,
the second indication information and/or the third indication information indicate(s) via a bitmap an active or inactive state of the path to which the DRB identity i or index i corresponds.

45. The apparatus according to any one of supplements 40-44, wherein,
the second indication information is transmitted via an RRC message or a PDCP control PDU or an MAC CE, and/or
the third indication information is transmitted via a PC5-RRC message or a PC5 SRAP control PDU or a PC5 MAC CE.

46. A multi-path processing method, applicable to a relay user equipment and including:
receiving second indication information transmitted by a network device, the second indication information including information on activation and/or deactivation and/or handover of an indirect path.

47. The method according to supplement 46, wherein the method further includes:
transmitting third indication information to a remote user equipment after receiving the second indication information, the third indication information including information on activation and/or deactivation and/or handover of the indirect path.

48. The method according to supplement 46 or 47, wherein the method further includes:
performing activation and/or deactivation and/or handover of the indirect path according to the second indication information.

49. The method according to supplement 47 or 48, wherein,
the second indication information and/or the third indication information include(s) at least one of the following:
a data radio bearer (DRB) identity, a logical channel identity (LCID) or index, a radio link control (RLC) entity (or bearer or channel) identity or index, or path state indication information.

50. The method according to supplement 49, wherein,
the logical channel identity or index or the RLC entity (or bearer or channel) identity or index is used for: activating or deactivating an RLC entity (or bearer or channel) and/or a logical channel in a case where use of more than one RLC entities and/or logical channel transmissions by a radio bearer is supported on a PC5 interface of the indirect path.

51. The method according to supplement 47 or 48, wherein,
the second indication information and/or the third indication information indicate(s) via a bitmap an active or inactive state of the path to which the DRB identity i or index i corresponds.

52. The method according to any one of supplements 47-51, wherein,
the second indication information is transmitted via an RRC message or a PDCP control PDU or an MAC CE, and/or
the third indication information is transmitted via a PC5-RRC message or a PC5 SRAP control PDU or a PC5 MAC CE.

53. A relay user equipment, including a memory and a processor, the memory storing a computer program, and the processor being configured to execute the computer program to carry out the multi-path processing method as described in any one of supplements 46-52.

54. A communication system, including the remote user equipment as described in supplement 19 and/or the network device as described in supplement 38 and/or the relay user equipment as described in supplement 53.

1. A multi-path processing apparatus, comprising:
a receiver configured to receive first indication information, the first indication information comprising information on activation and/or deactivation of a direct path and/or an indirect path for a data radio bearer; and
a processor configured to perform activation and/or deactivation of the direct path and/or the indirect path, according to the first indication information.

2. The multi-path processing apparatus according to claim 1, wherein,
the first indication information comprises at least one of the following: a data radio bearer identity, a radio link control (RLC) entity identity or index, path usage indication information.

3. The multi-path processing apparatus according to claim 2, wherein,
the radio link control entity identity or index is used for: activating or deactivating a radio link control entity and/or a logical channel in a case where use of more than one radio link control entities and/or logical channel transmissions is supported on a PC5 interface of the indirect path.

4. The multi-path processing apparatus according to claim 2, wherein,
the first indication information is transmitted via a media access control (MAC) control element (CE).

5. The multi-path processing apparatus according to claim 2, wherein,
the path usage indication information indicates the information on whether split transmission or duplication transmission is used between the direct path and the indirect path for the data radio bearer.

6. The multi-path processing apparatus according to claim 5, wherein,
when duplication transmission is used between the direct path and the indirect path for the data radio bearer, same PDCP PDU is delivered to a RLC entity corresponding to the data radio bearer in the direct path and a PC5 RLC entity corresponding to the data radio bearer in the indirect path.

7. The multi-path processing apparatus according to claim 1, wherein,
the indication information comprises third indication information transmitted by a relay user equipment,
the third indication information comprising at least one of the following: a data radio bearer identity or index, a logical channel identity or index, a radio link control entity identity or index, or path state indication information, or,
the third indication information indicating, via a bitmap, the activation or deactivation state of the path to which the data radio bearer identity or index corresponds.

8. A multi-path processing apparatus, comprising:
a transmitter configured to transmit first indication information to a remote user equipment or a relay user equipment; the first indication information comprising information on activation and/or deactivation of a direct path and/or of an indirect path for a data radio bearer.

9. The multi-path processing apparatus according to claim 8, wherein,
the first indication information comprises at least one of the following: a data radio bearer identity, a radio link control entity identity or index, path usage indication information, or path state indication information.

10. The multi-path processing apparatus according to claim 9, wherein,
the radio link control entity identity or index is used for: activating or deactivating a radio link control entity and/or a logical channel in a case where use of more than one radio link layer control entities and/or logical channel transmissions are supported on a PC5 interface of the indirect path.

11. The multi-path processing apparatus according to claim 9, wherein,
the first indication information is transmitted via a media access control (MAC) control element (CE).

12. A multi-path processing apparatus, comprising:
a receiver configured to receive second indication information transmitted by a network device, the second indication information comprising information on activation and/or deactivation of an indirect path.

13. The multi-path processing apparatus according to claim 12, further comprising:
processor circuitry configured to perform activation and/or deactivation of the indirect path according to the second indication information.

14. The multi-path processing apparatus according to claim 12, further comprising:
a transmitter configured to transmit third indication information to a remote user equipment after the receiver receives the second indication information; wherein the third indication information includes information on activation and/or deactivation of the indirect path.

15. The multi-path processing apparatus according to claim 14, further comprising:
the second indication information and/or the third indication information comprise(s) at least one of the following: a data radio bearer identity or index, a logical channel identity or index, a radio link control entity identity or index, or path state indication information; or,
the second indication information and/or the third indication information indicate(s) via a bitmap, an activation or deactivation state of a path to which the data radio bearer identity or index corresponds.

16. The multi-path processing apparatus according to claim 15, wherein,
the logical channel identity or index or the radio link control entity identity or index is used for: activating or deactivating a radio link control entity and/or a logical channel in a case where use of more than one radio link control entities and/or logical channel transmissions are supported on a PC5 interface of the indirect path.

17. The multi-path processing apparatus according to claim 16, wherein,
the second indication information is transmitted via a radio resource control message or a packet data convergence protocol control packet data unit or a media access control (MAC) control element (CE); and/or
the third indication information is transmitted via a PC5 radio resource control message or a PC5 sidelink relay adaptation protocol control packet data unit or a PC5 medium access control (MAC) control element (CE).
